(19) United States
(12) Patent Application Publication
(10) Pub. No.: US 2006/0235967 A1
(43) Pub. Date: Oct. 19, 2006

(54) System and method for exchange of information amongst peers in a peer to peer wireless network

(75) Inventor: Charles W. Fritz, Fort Myers, FL (US)

Correspondence Address: ANTHONY R. BARKUME, 20 GATEWAY LANE, MANORVILLE, NY, 11949, US

(73) Assignee: NEOMEDIA TECHNOLOGIES, INC., Fort Myers, FL (US)

(21) Appl. No.: 11/406,516

(22) Filed: Apr. 18, 2006

Related U.S. Application Data
(60) Provisional application No. 60/673,306, filed on Apr. 19, 2005.

(51) Int. Cl. G06F 15/173

(52) U.S. Cl. 709/224

(57) ABSTRACT

A method and system for exchanging information amongst a plurality of peers. A first peer collects environment data related to an environment proximate to the first peer, which may for example be associated with a traffic or weather condition proximate to the first peer. The first peer transmits the environment data into a first region associated with the first peer, and a second peer receives the environment data transmitted by the first peer. The second peer then processes the received environment data. This process would likely occur in an iterative manner; i.e. the second peer retransmits the information to other peers in its operating range, and may add its own collected environment data as well.

### CROSS-REFERENCE TO RELATED APPLICATIONS

This application is based on and claims priority from co-pending U.S. Provisional Application Serial No. 60/673,306, which was filed on Apr. 19, 2005, which is incorporated by reference herein.

### TECHNICAL FIELD

The present invention relates to a wireless peer to peer network in which peers gather, process and exchange information with each other without reliance on a central server.

### BACKGROUND ART

Computer and other types of communication networks are increasingly ubiquitous, in both wired and wireless forms. Wireless networks allow member devices to move with respect to each other and maintain connectivity with the network. A primary example of this is a cellular telephone network, in which callers may travel with respect to each other and maintain a telephone call. Wireless networks often integrate with wired networks, such as with the cellular telephone network. Thus, when one mobile caller connects with another mobile caller, the connection is made from the first mobile device, through the wireless network, then into the land line network, then back to another cell in the wireless network.

Networks may be based on a client-server model or on a peer to peer topology. In a client server model, a server maintains connectivity with each client and manages communications between itself and a client or between client devices. A peer to peer network allows direct communications between two devices without requiring intervention by a server or host computer.

The present invention utilizes the concepts of peer to peer computing in a wireless network to provide essential information to be exchanged between and amongst mobile devices, a prime example of which are automobiles traveling to and from their destinations.

### DISCLOSURE OF THE INVENTION

The present invention is a method and system for exchanging information amongst a plurality of peers. A first peer collects environment data related to an environment proximate to the first peer, which may for example be associated with a traffic or weather condition proximate to the first peer. The first peer transmits the environment data into a first region associated with the first peer, and a second peer receives the environment data transmitted by the first peer. The second peer then processes the received environment data. This process would likely occur in an iterative manner; i.e. the second peer retransmits the information to other peers in its operating range, and may add its own collected environment data as well.

The second peer may obtain environment data by transmitting a request for environment data that is received by the first peer, in which case the first peer would transmit the environment data into the first region associated with the first peer in response to the request for environment data received by the first peer. In the alternative, the first peer may transmit the environment data without requiring a request for said environment data (e.g. on a periodic basis or as a result of an external stimulus such as detection of an adverse weather event).

In this system, the first peer may collect environment data from at least one sensor, from a user input device, from another peer, and/or from a remotely located data source.

The environment data collected by the first peer may include peer location data, which may be GPS coordinate information of (i) the first peer obtained from an associated GPS receiver, or (ii) GPS coordinate information of at least one other peer obtained from a wireless transmission from another peer. The GPS coordinate information of at least one other peer may include GPS coordinate information of a plurality of peers, wherein the second peer processes the GPS coordinate information to determine if a congested traffic condition exists in proximity to the plurality of peers. The second peer may then make a change in an intended route based on the determination if a congested traffic condition exists in proximity to the plurality of peers.

### BRIEF DESCRIPTION OF THE DRAWING

FIG. 1 is an illustration of an application of the present invention in a traffic monitoring environment.

FIG. 2 is a block diagram of a peer device of the present invention.

FIG. 3 is an illustration of an example of peer interaction of the present invention.

FIG. 4 is a flowchart of the invention.

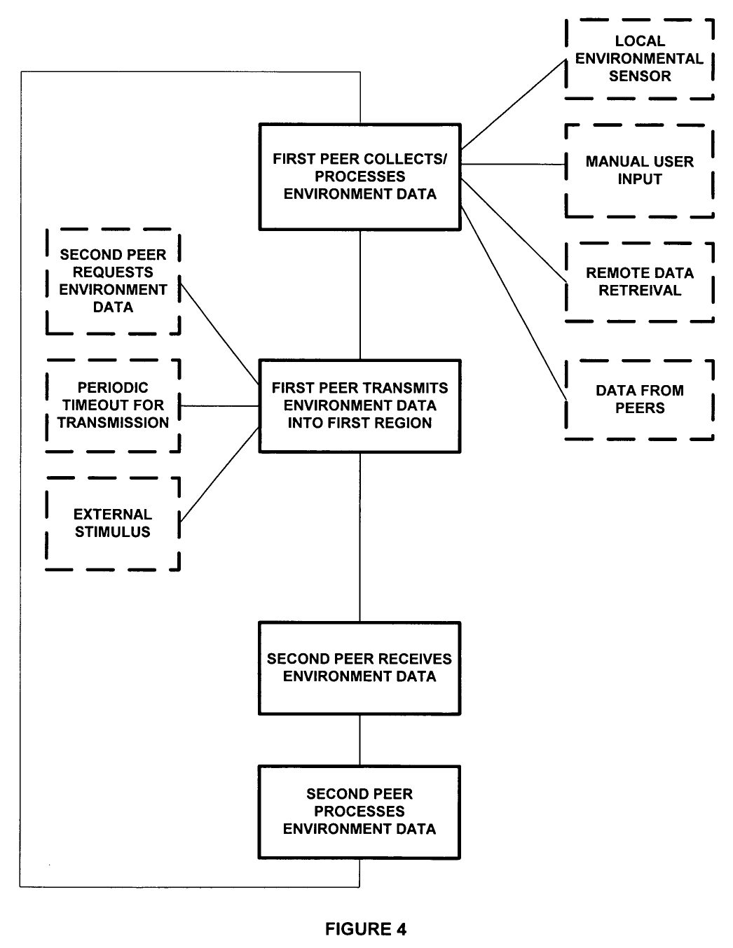

### BEST MODE FOR CARRYING OUT THE INVENTION

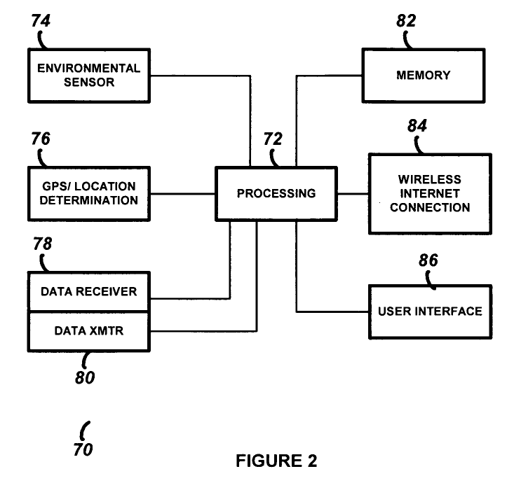

The present invention is a system and method for exchanging information amongst a plurality of peer devices in a peer to peer manner. In a preferred embodiment, each peer is an automobile (e.g. a car, truck, SUV, motorcycle, etc.), referred to herein generically as a car. Each car is equipped with a peer computing device 70 as shown in FIG. 2. Each peer computing device 70 has, at a minimum, processing circuitry 72, a memory 82, a user interface 86, and a data receiver 78 and data transmitter 80. The processing circuitry 72 may be a microprocessor and related circuitry, microcomputer, or some similar device programmed to carry out the functionality of this invention. A memory 82 is provided that will store information (such as in a database) as described herein, for example: information on other peers detected to be proximate to that peer computing device 70, detected weather conditions, etc. The user interface 86 allows a user to interoperate with the peer computing device 70, and may include for example, a display and/or speaker, an input device such as a keyboard or mouse or microphone for voice recognition, or a combination device such as a touchscreen device that includes both input and out functions. The data receiver 78 and data transmitter 80 are generally known in the art and are adapted to receive and transmit data with other peers such as by RF transmission. Thus, information transmitted by one peer computing device will be transmitted by the data transmitter 80 of that peer computing device and then received by the data receiver 78 of another peer computing device and processed accordingly as described herein.

Each peer computing device 70 may also have one or more of the following components. An environmental sensor device(s) 74 operates to sense environmental conditions in the proximate region of the car, such as a weather condition. As described herein, the weather condition sensed by the environmental sensor 74 may be stored in memory 82, processed locally by processing circuitry 72, and/or transmitted to another peer(s) by data transmitter 80.

Each peer computer may also have a location determining device such as a GPS receiver 76 programmed to ascertain the location of the peer computing device at any given time. As described herein, the location information determined by the GPS receiver 76 may be stored in memory 82, processed locally by processing circuitry 72, and/or transmitted to another peer(s) by data transmitter 80.

Each peer computer may also have a wireless network connection 84 adapted to enable the peer computing device 70 to interact with the Internet (or another external network). As described herein, this will enable the peer computing device to obtain or provide external information relevant to the location proximate to the peer, such as local weather conditions, etc.

The present invention allows the peers to communicate with each other when they come within communication range of each other, which is dictated by the parameters of the wireless communication system implemented with the data receiver 78 and the data transmitter 80 (including hardware as well as protocol requirements). Each peer may transmit information stored in its memory 82, may receive information from another peer(s), and may process the information sensed and received in accordance with the invention described herein.

An advantage of the peer-to-peer aspect of the present invention is that peers may communicate with one another as long as they are in proximity of each other as a function of the operation of the transmitter 80 and the receiver 78. That is, the transmitter/receiver pairs will have a defined range which may be set by the system designers. For example, it may be desired to have a communication range of ½ mile in a given region, so that all peers within ½ mile of each other may easily communicate, and they will be unable to communicate with each other if they are outside this range. The range may be determined based on the density of users in a given area so as to prevent overloading of the system. Thus, it may be desired to have a greater range in a less populated area, but a smaller range in a more densely populated area in order to prevent overloading the capabilities (e.g. processing and memory) of the peer computing devices.

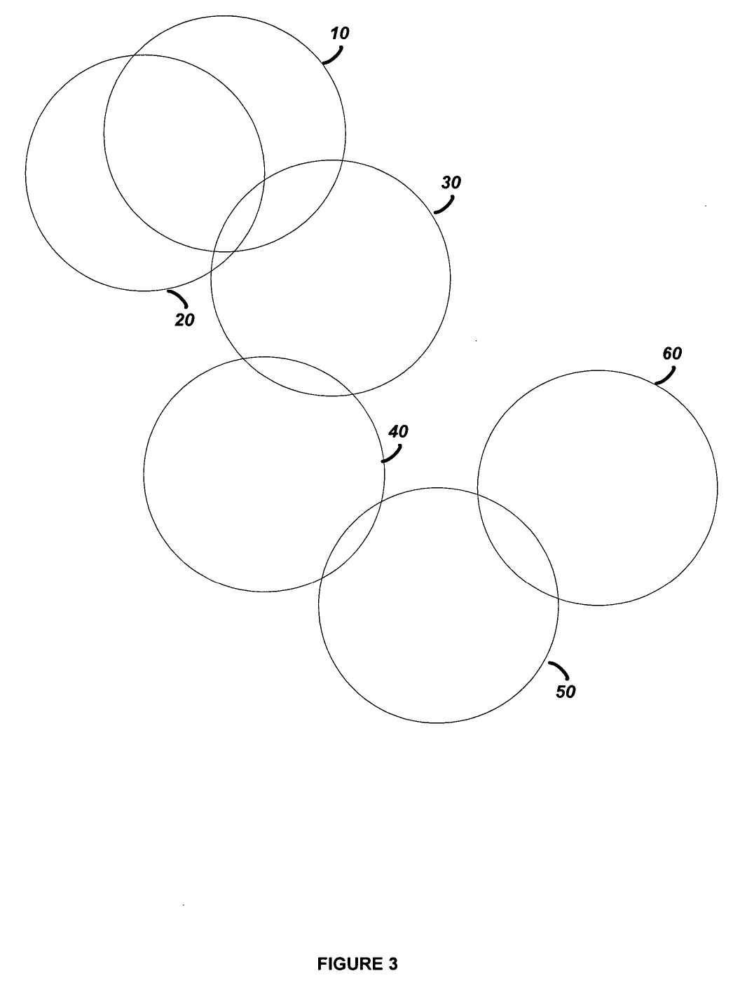

FIG. 3 illustrates a simple example of the interaction between peers in this invention. Communication regions 10, 20, 30, 40, 50 and 60 are shown, some of which partially overlap with another. Note that communication regions may not actually be circular but may have other patterns determined by signal strength, antenna configurations, etc. A peer computing device 70 is located at the center of each communication region (not shown), which of course define the region's location at a given time based on the communication range as explained above. In this example, peers 10 and 20 are fairly close to one another, and are also close enough to peer 30 so that they all overlap each other. Thus, peers 10, 20 and 30 can communicate with each other and exchange information with each other in accordance with the invention as will be further described. However, peer 40 is too far from peers 10 and 20 to communicate with them, but is able to communicate with peer 30. Likewise, peer 50 is too far from peers 10, 20 and 30 to communicate with them, but is able to communicate with peer 40; and peer 60 is too far from peers 10, 20, 30, and 40 to communicate with them, but is able to communicate with peer 50. The present invention provides for peer 40 to exchange information with peer 30 and peer 50, and peer 50 to exchange information with peer 40 and peer 60. The result is that all peers in this system are able to exchange information with each other even though they are too far from some peers to directly communicate with those distant peers. In addition, intermediate peers may process and/or add further information that would otherwise be unobtainable if there were direct communication between distant peers. That is, peer 40 can collect information from peer 30 (which may include information from peers 10 and 20 as well), and then add its own environmental information to provide to peer 50.

For example, one peer may have information stored in its memory 82 regarding traffic congestion at a certain location (it can determine its location at any time with the GPS receiver 76). The peer may broadcast this as a traffic alert as it continues on its journey. Other peers approaching and passing the first peer may receive that information and process it, informing the driver via the user interface 86 of the upcoming traffic problem. Alternative routes may be suggested using the GPS receiver 76 as well as traffic information obtained from other peers that may have approached from other directions and passed along pertinent information. This may all occur in a real time fashion as further described herein.

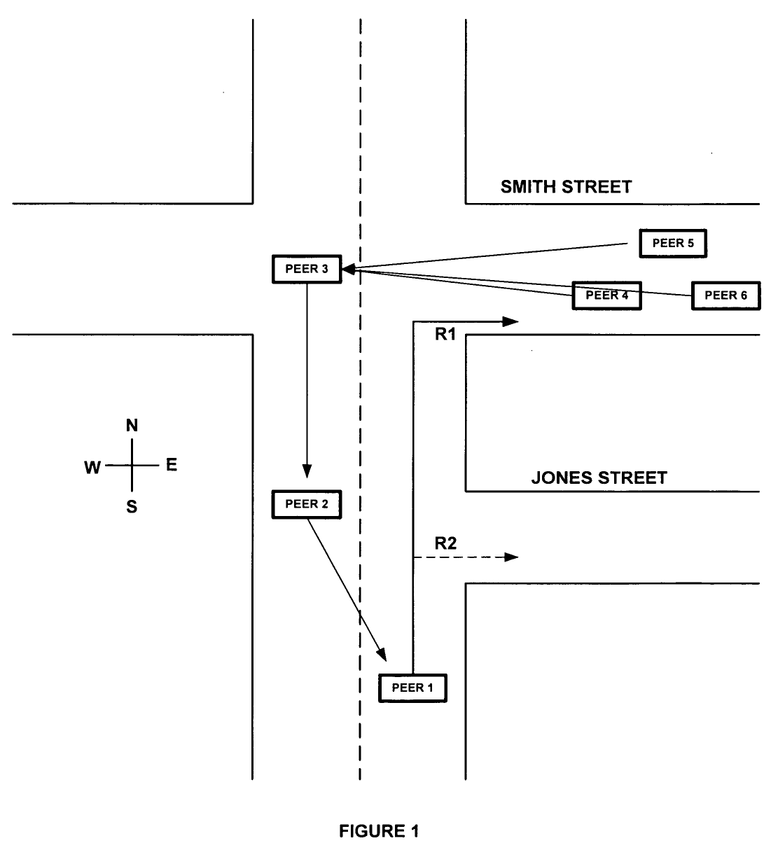

FIG. 1 shows this exemplary situation. Peer 4, peer 5, and peer 6 all broadcast location information within an operational range that includes peer 3. The location information may include geographic coordinates that are obtained from the GPS receiver 76, or the GPS coordinates may be translated at each peer into street identification information, etc. In any event, this information is periodically broadcast by each of peer 4, peer 5 and peer 6, and received by peer 3. Peer 3 receives the GPS information and calculates that peer 4, peer 5 and peer 6 are clustered together and traveling east on Smith Street, and as a result peer 3 determines that there is traffic congestion in that area at that time. Peer 3 then in turn broadcasts this information, which is received by peer 2 which is within its range. Peer 2 does not intend on traveling along Smith Street but nonetheless rebroadcasts that information, which is received by peer 1 which is within range of peer 2. Peer 1 had intended on traveling east on Smith Street, but now has been informed that there is traffic congestion on its intended route (R1). Peer 1 recalculates the route to take R2, which is east on Jones Street. Although R2 is not normally as fast as R1, in this case R2 will be a better choice due to the congestion on Smith Street. Peer 1 thus avoids the traffic congestion on Smith Street due to the present invention.

Note that the information broadcast by peer 4, peer 5 and peer 6 may also be received directly by peer 2 and/or peer 1 depending on the signal strength, receiver sensitivity, environmental factors, distance between peers, etc. However, by receiving and rebroadcasting information, the present invention provides for peer to peer interoperation and ensures that all peers in the network will benefit.

Rerouting in this example from R1 to R2 may be done manually or automatically. For example, the GPS system may receive the traffic congestion information and automatically calculate and display the new route R2 to the driver via the user interface 86. In the alternative, the GPS may display a graphic to the driver indicating traffic congestion along R1 and allow him or her to make the appropriate route adjustment manually.

In another example, weather conditions may be sensed by associated sensors, and the information stored in memory 82, processed by processing circuitry 72, and transmitted to other peers to alert them accordingly. For example, a car having a peer computing device 70 onboard may drive through a snow squall and broadcast this information to approaching peers so they may act accordingly (e.g. by changing route, slowing down or pulling over, etc.).

Information such as weather and traffic conditions may be automatically sensed (e.g. by an environmental sensor 74) and calculated as just described, or it may be manually input into the peer computing device by the driver or passenger. A touchscreen device may be used that allows selection of options such as “enter weather conditions”, which when selected may allow the user to designate icy roads, snow conditions, etc. This information is collated with GPS coordinate information and broadcast to peers in the network as described above.

Vehicles having a peer computing device 70 onboard may be identified by any unique identification, for example a Vehicle Identification Number (VIN). Since each vehicle will have a unique VIN, this may be encoded with each broadcast so that each peer may be identified and distinguished from other peers for calculation purposes. Thus, when peer 4 broadcasts its coordinates it may be in the format:

| | | |
|---|---|---|
| X1, Y1 | VIN#12345 | timestamp: 11:18:05 AM |
| X2, Y2 | VIN#12345 | timestamp: 11:18:10 AM |
| X3, Y3 | VIN#12345 | timestamp: 11:18:15 AM |

Any peer that receives this information can then calculate the location of peer 4, its speed, its direction, etc. As this information is received and sorted by VIN, it allows the receiving peer to make determinations as to traffic conditions at any given location X,Y.

Thus, the memory 82 may have a database table or the like having a multitude of records that list the peer ID, its X/Y coordinates (or X/Y/Z coordinates if a 3D system is used), and the timestamp of those coordinates.

Use of a unique ID such as a VIN also allows for authentication between peers so that only authorized peers can benefit from the present invention. A system operator may require registration and then only allow authorized or authenticated peers to collaborate and benefit from the system. In this event, each peer would have be able to authenticate authorized peers based on a lookup table, algorithm, etc.

In addition, a peer may be able to obtain external information about a communicating peer if desired. The external information may be obtained for example from a web server via a wireless Internet connection 84 at the peer. For example, peer 1 broadcasts its VIN, which is received by peer 2. Peer 2 uses the received VIN and accesses a data repository on the Internet to learn information that may be stored there that is correlated to that VIN. The operator of peer 1 may have a website with personal information, interests, etc. that he or she wishes to make available to other peers in real time. In one example, the operator of peer 1 may wish to sell his vehicle, and he may set up a website, associated with his VIN, that includes a description of the vehicle, phone number of the operator, sale price, etc. When peer 2 receives this information from the Internet it may display it to the driver or passenger accordingly.

Peer networks may be chained together to ensure rebroadcasting of information not only within a peer network but across authorized networks. System operators may then keep track of peer-to-peer communications as well as network-to-network communications and allocate costs and expenses accordingly.

Peers may also exist as stationary objects, and may be associated with locations such as gas stations, hotels, and diners. For example, a gas station may include a peer computer and may be adapted to continuously broadcast the availability of gasoline at a sale price. This may be captured by peers within range of the gas station, and then re-broadcast as they travel away from the gas station. Another peer entering that vicinity may then receive this information and display it to the driver, who may then alter his plans to stop at the gas station for a fill up. Similarly, a hotel may broadcast the availability of rooms as well as the price, which may be broadcast to peers and retransmitted to other peers as well. A diner may broadcast items on its menu, prices, etc.

In addition to gathering information locally (from surrounding conditions such as traffic and weather), the present invention provides for the use of external data repositories in order to supplement and enhance the data being used by the system. For example, a peer may be able to determine certain weather conditions from (1) onboard sensors 74; (2) information received from other peers; and (3) the wireless Internet connection 84 linked to a weather website such as http://www.weather.com. In addition to receiving information from external data repositories, the peer computing devices are also enabled to optionally send local data to these databases. Thus, a peer could upload local conditions such as “icy roads” to the weather.com website. Likewise, a peer could upload traffic information, which could be received by a traffic website and made available to anyone with an Internet connection and a web browser (including other peers).

The present invention allows a multitude of independently operating peers to share information which each other in real time without requiring access to a central server. This allows peers to communicate with each other as needed, in disparate locations, etc.

As described, information may be transmitted or broadcast by a peer on a periodic basis. For example, a peer computing device 70 may be programmed to cause information to be broadcast every 5 seconds on a continuous basis. In this situation, any other peer within range would be able to receive the information automatically and then process it accordingly. In an alternative embodiment, information may be requested by a peer at any time, in addition to or as an alternative to periodic broadcasting. In this case, the peer computing device 70 would issue a request for information, which would be received by all of the peers within range of the requesting peer. In a simple example all peers would then respond with information in its memory, such as local weather conditions, traffic conditions, etc., determined as described above. Conditions may be imposed on the request, such as a request for adverse weather conditions only, or a request made to peers located on the intended route of the requesting per, etc. Likewise, peers may be adapted to respond only to certain other peers and not respond to other peers.

Likewise, a peer may be programmed to broadcast information when a certain condition or external stimulus is detected. For example, a peer may detect that there is traffic congestion at a certain location, and this may trigger a traffic alert to be broadcast to warn nearby drivers.

In an alternative embodiment, energy or power may be transmitted from one peer to another. Thus, a peer may collect energy or power from more than one peer in accordance with the principles of the present invention.

I claim:

1. A method for exchanging information amongst a plurality of peers comprising the steps of:
a first peer collecting environment data related to an environment proximate to the first peer;
the first peer transmitting said environment data into a first region associated with the first peer;
a second peer receiving the environment data transmitted by the first peer; and
the second peer processing the received environment data.

2. The method of claim 1 further comprising the steps of:
the second peer transmitting a request for environment data;
the first peer receiving the request for environment data transmitted by the second peer; and
the first peer transmitting said environment data into the first region associated with the first peer in response to the request for environment data received by the first peer.

3. The method of claim 1 wherein the first peer collects environment data from at least one sensor.

4. The method of claim 1 wherein the first peer collects environment data from a user input device.

5. The method of claim 1 wherein the first peer collects environment data from a remotely located data source.

6. The method of claim 1 wherein the first peer collects environment data from another peer.

7. The method of claim 3 wherein the environment data collected by the first peer is associated with a weather condition proximate to the first peer.

8. The method of claim 3 wherein the environment data collected by the first peer is associated with a traffic condition proximate to the first peer.

9. The method of claim 1 wherein the environment data collected by the first peer comprises peer location data.

10. The method of claim 9 wherein the peer location data comprises GPS coordinate information of the first peer obtained from an associated GPS receiver.

11. The method of claim 9 wherein the peer location data comprises GPS coordinate information of at least one other peer obtained from a wireless transmission from another peer.

12. The method of claim 11 wherein the GPS coordinate information of at least one other peer comprises GPS coordinate information of a plurality of peers, and wherein the second peer processes the GPS coordinate information to determine if a congested traffic condition exists in proximity to the plurality of peers.

13. The method of claim 12 wherein the second peer makes a change in an intended route based on the determination if a congested traffic condition exists in proximity to the plurality of peers.

14. A wireless peer to peer information exchange system comprising a plurality of peer computing devices, each of said peer computing devices comprising:
means for collecting environment data related to an environment proximate to the peer computing device;
means for transmitting said environment data into a region associated with the peer computing device;
means for receiving environment data transmitted by another peer computing device; and
means for processing the environment data.

15. The system of claim 14, wherein the means for collecting environment data comprises an environmental sensor.

16. The system of claim 14 wherein a peer computing device further comprises a memory for storing environment data.

17. The system of claim 14 wherein a peer computing device further comprises means for determining the location of the peer computing device.

18. The system of claim 14 wherein the means for determining the location of the peer computing device comprises a GPS receiver.

19. The system of claim 14 wherein a peer computing device further comprises a user interface.

20. The system of claim 14 wherein a peer computing device further comprises a wireless network connection.
